(19) United States
(12) Patent Application Publication
(10) Pub. No.: US 2015/0027057 A1
(43) Pub. Date: Jan. 29, 2015

(54) Door State Sensor

(71) Applicant: Google Inc., Mountain View, CA (US)

(72) Inventors: Joe Freeman Britt, Jr., Los Altos, CA (US); William Wurz, San Francisco, CA (US); Shawn Ellis, Sunnyvale, CA (US); Paul Heninwolf, San Carlos, CA (US)

(73) Assignee: Google Inc., Mountain View, CA (US)

(21) Appl. No.: 13/951,488

(22) Filed: Jul. 26, 2013

(51) Int. Cl. G08B 7/06; E05F 15/20

(52) U.S. Cl. CPC G08B 7/06; E05F 15/2076
USPC 49/14; 49/506; 49/13

(57) ABSTRACT

Doors such as garage doors can be automated by pushing commands to a removable device attached to the garage door. The state of the door (e.g. whether the door is open or closed) may be obtained from a position sensor located within a removable device. An implementation may indicate, over a wireless network, the state of the door to a user. The user may send a command to a wireless transmitter located within the device to change the state of the door. An implementation may also send a signal to the door to change the state of the door.

### BACKGROUND

Conventional garage door openers typically include a transmitter and a receiver within the garage, which, upon receiving a radio signal from the transmitter, actuates a drive mechanism that opens and closes the garage door. Transmitters typically have a limited range. Therefore, most garage doors are not capable of being opened or closed from far away. The driver of an automobile typically carries the transmitters of such conventional garage door openers. This allows the driver the ability to actuate the garage door function when in relative proximity to the receiver within the garage.

### BRIEF SUMMARY

The present disclosure is directed to methods and devices for remote monitoring and controlling a door, such as a garage door. An implementation may obtain a state of the door from a position sensor located within a removable device, which may be attached to the door. The state of the door may include whether the door is open or closed. An implementation may indicate, over a wireless network, the state of the door to a user. The user may send a command to a wireless transmitter located within the device to change the state of the door. An implementation may also send a signal to the door to change the state of the door.

In accordance with another aspect of the disclosed subject matter, a device may include a processor, position sensor and a wireless transmitter. The position sensor may be configured to obtain a state of a door, such as a garage door. The processor may be configured to indicate, over a wireless network, the state of the door to a user. A wireless transmitter may be configured to receive a command from the user to change the state of the door. A device may also include an attachment mechanism for attaching to the door. The removable device may weigh no more than about 300 g, and may have at least one dimension not more than about 120 mm. It also may be 60mm thick or less.

In an implementation of the disclosed subject matter, a second wireless transmitter may be configured to send a signal to a door control mechanism, such as a garage door opener, to change the state of the door. In an implementation, a user may be a person who desires to change the state of the door. The user may also be an automated system, such as a home automation system that is capable of being configured by a user.

Additional features, advantages, and implementations of the disclosed subject matter may be set forth or apparent from consideration of the following detailed description, drawings, and claims. Moreover, it is to be understood that both the foregoing summary and the following detailed description provide examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 is a flow chart illustrating a method for remote monitoring and controlling a garage door according to an implementation of the disclosed subject matter;

FIG. 2 is a block diagram illustrating a communications network including a system for practicing aspects of the present implementation of the disclosed subject matter.

FIG. 3A is a schematic representation of a garage door according to an implementation of the disclosed subject matter.

FIG. 3B is a schematic representation of a garage door with an attached removable device according to an implementation of the disclosed subject matter.

FIG. 4 shows a computer according to an implementation of the disclosed subject matter.

FIG. 5 shows a network configuration according to an implementation of the disclosed subject matter.

### DETAILED DESCRIPTION

Implementations of the disclosed subject matter relate generally to controlling and determining the state of a door, such as a garage door. More specifically, implementations relate to a removable device that attaches to an existing door and provides remote monitoring and control. For example, the device may attach to an existing garage door, and provide an indication to a remote user of the state of the garage door, such as whether the door is open, closed, or partially open. The device also may interface with an existing mechanism that controls the state of the door, such as a preexisting garage door opener or similar mechanism.

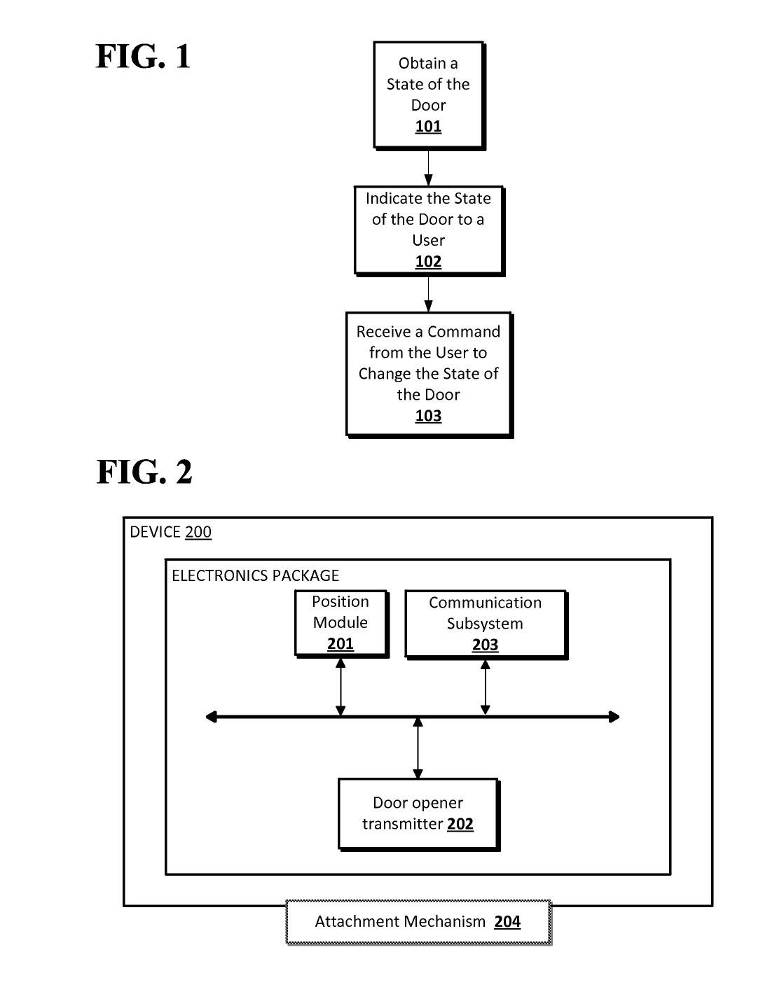

Referring now to the drawings wherein the showings are for purposes of illustrating implementations of the disclosed subject matter only and not for purposes of limiting the same, FIG. 1 shows an example method for remote monitoring and controlling a garage door according to the present disclosure.

At 101, a state of the door may be obtained from a position sensor as disclosed herein. The position sensor may directly measure the position of the door and, from the position, infer the state of the door. For example, a position sensor may determine that a garage door is horizontal, and it then may be determined that the garage door is completely open. Similarly, the position sensor may determine that the door is completely vertical, or that a portion of the door is at an angle between horizontal and vertical, in which case it may be determined that the door is closed or partially open, respectively.

At 102, the state of the door may be provided to a user, such as via a wireless network. A user may be a person located at a mobile device, such as a laptop, ultraportable computer, tablet computer, wristwatch, cell phone, portable media device or other handheld electronic device, who desires to change the state of the door. Alternatively or in addition, a user may receive an indication of the door state at a desktop computer, kiosk, special-purpose computer, or any other suitable computing device. A “user” also may include an automated system, such as a home automation system, which may be configurable by a human operator. The state of the door can also be requested by the user himself (e.g., by inquiring into the door's state within a mobile interface) or it may be determined by a home automation system. For example, an implementation may be configured to indicate the state of the door to the home automation periodically, absent any specific request from a user.

The user may send a command at 103 to change the state of the door. The state change command may indicate the user desires the door to be in the open or closed position. As another example, the door may have two standard states, such as open and closed, and the command may indicate that the door should be placed in the state other than the state in which it currently exists. A user may send a command to change the state of the door via different processes. For example, a person located at a mobile device may send a command to change the state of the door though a mobile interface. Likewise, a user may send a command to change the state of the door via an interface of a home automation or similar system. In response to the user command, a wireless transmitter incorporated into a device as disclosed herein may send a command that causes the door to change state. The command may be sent to a separate mechanism that controls the state of the door. For example, a transmitter in the device may send a signal to a conventional garage door opener that causes the garage door opener to change state.

FIG. 2 shows a device 200 for remotely monitoring and controlling a door such as a garage door as disclosed herein. The device 200 may include an electronics package, which may be include a position module 201 and a signifying module 202. The position module 201 may obtain a state of a door as described above. The position sensor may include, for example, a gyroscope, an accelerometer, rotary encoder, potentiometer, or other similar absolute position or displacement position sensors to determine the state of the garage. In some configurations the device may include multiple sensors of the same or different types, such as multiple position sensors that are used to determine if the door is in a partially-open state. More generally, the state of the garage door may include whether the door is open or closed, whether the door is partly open, shifted off track, or the like. For example, an implementation may include a mechanical or electronic gyroscope that measures the vertical orientation of a garage door when the door is closed. Likewise, an implementation may include a rotary encoder or similar mechanism that converts the horizontal angular position to a digital signal that indicates the state of a garage door. As another example, a sensor may determine the angular position of a conventional hinged door to determine if the door is open, closed, partially open, or in any other detectable state.

In some configurations, multiple devices maybe attached to a single door, each of which may include one or more sensors and may be in communication with each other and/or with a user or other system as disclosed herein. Each device may include some or all of the components disclosed herein, or one or more of the multiple devices may include a simpler or reduced set of components, such as where one device is a “master” device as disclosed herein, which may aggregate data received from one or more other devices. The one or more other devices may be of reduced complexity, such as where each includes only a sensor, a communication module to communicate with the master device, and associated circuitry to allow the device to communicate a sensor indication to the master device. Configurations using multiple devices may be useful, for example, to more precisely or more accurately determine the state of a door. As a specific example, one device may be positioned near the bottom of a garage door and another near the top of the door. Data from position sensors or other sensors within the devices may then be analyzed to determine the degree to which the door is open. For example, if the “top” device indicates that the top portion of the door is completely horizontal and the “bottom” device indicates that the bottom portion of the door is at an angle between horizontal and vertical, it may be determined that the door is almost completely open, more than half open, more than two-thirds open, or the like.

A communication subsystem 203 may receive a command from the user, such as via a wireless network, to change the state of the door as described herein. The communication subsystem 203 may be capable of connecting to any suitable wireless network, such as standard or proprietary home wireless networks. The communication subsystem 203 may connect to a wireless network using wireless techniques, including digital cellular telephone connection, digital satellite data connection or the like, and/or other wireless network techniques, such as IEEE 802.11x or the like. More generally, the removable device may connect to a wireless local area network, personal area networks, metropolitan area networks, and wide area networks or any other wireless network accessible by a user. In some implementations, the communication subsystem also may interface with an existing door control mechanism such as a garage door opener, such as by sending an open/close signal to the mechanism.

An implementation of the removable device may have a second wireless transmitter configured to connect to a mechanism, such as a garage door opener, that is capable of changing the state of the door. For example, if a garage door is in an open state, the device may send an instruction to the garage door opener to close the garage door. The garage door opener may receive this instruction and operate normally, in the same fashion as if the signal was received from the associated original transmitter. Conventional garage door openers include a receiver within the garage, which, upon receiving a radio signal from an associated transmitter, actuates a drive mechanism that opens or closes the garage door. In some implementations, the garage door opener may be a conventional garage door opener, that is configured to operate in an identical fashion regardless of whether instructions are received from a device as disclosed herein, or from an associated transmitter such as is commonly kept within a vehicle or by a driver. Similarly, other remote-controlled doors may include or interface with an existing door state control mechanism, such as a motorized controller that is configured to open and/or close the door. Thus, in some configurations, the device 200 may include a transmitter that can replicate an open/close signal as would be sent by an original transmitter for the door control mechanism. The transmitter may be implemented by the communication subsystem 203, or it may be a physically-separate, special-purpose transmitter configured to provide a signal to the door controller. FIG. 2 shows an example configuration that includes a separate transmitter 202, but it will be understood that similar functionality and features may be obtained by implementing the transmitter 202 as part of the communication subsystem 203.

The device 200 may include an attachment mechanism 204 configured to attach to a door as described herein. Suitable attachment mechanisms may include, for example, a smooth surface where adhesive may be applied, pre-existing pocket holes on the device that allow for screws to be drilled, pre-existing adhesive with a removable sheet to expose the adhesive, a nail, screw, or similar device, a magnet, and other components suitable for attaching the device to a door.

In implementations of the disclosed subject matter, a removable device as disclosed herein, such as the device 200 in FIG. 2, can be relatively lightweight and slender. For example, in an implementation the device may weigh less than 300 g and may have at least one dimension no more than 120 mm, and depth of not more than about 60 mm. As another specific example, a device as disclosed herein may weigh not more than about 300 g, 200 g, 100 g, 50 g, or the like, and may have a volume of not more than about 30,000 mm³, 40,000 mm³, 50,000 mm³, 60,000 mm³ or the like. Notably, the use of a relatively small physical form factor may alleviate or prevent issues that could arise when attaching the device to a garage door via an attachment mechanism as disclosed herein. For example, a lightweight removable device weighing 140 g or less and having a depth of 7.5 mm or less may be capable of attaching to the garage door panel using conventional drying adhesives, such as white glue, contact adhesive, rubber cement, or similar attachment mechanisms. As a result of being relatively lightweight and slender, a user may easily attach and remove the device from the door at his discretion. It will be understood that the specific dimensions used in this example are illustrative only and that, more generally, the device may be sufficiently small so as to be handled in a single hand of the user, and/or sufficiently small and sufficiently lightweight so as to be attachable to a door using relatively simple attachment mechanisms as disclosed herein.

As previously described, implementations of the disclosed subject matter may interface with a home automation system, such as by way of a communication subsystem 203 as described with respect to FIG. 2. The home automation system may be configured to send a command to change the state of a door automatically. For example, if a device as disclosed herein indicates the door is open after a time period designated by a user, the home automation system may send a command to close the door automatically. As another example, the home automation system may track the presence or absence of one or more automobiles used by a family or household. If a garage door is open when all automobiles are present in the garage, the home automation system may send a command to close the garage door automatically. Recognizing the arrival of vehicles associated with a home may be accomplished by known techniques of obtaining signal strength data associated with the vehicles, image recognition techniques or other known techniques of vehicle recognition. Upon receiving a command to change the state of the garage door, a signal may be sent to an existing motorized garage door opener to change the state of the garage door as previously described. More generally, the home automation system may be configured to control the state of a door according to any parameters set by a user of the system.

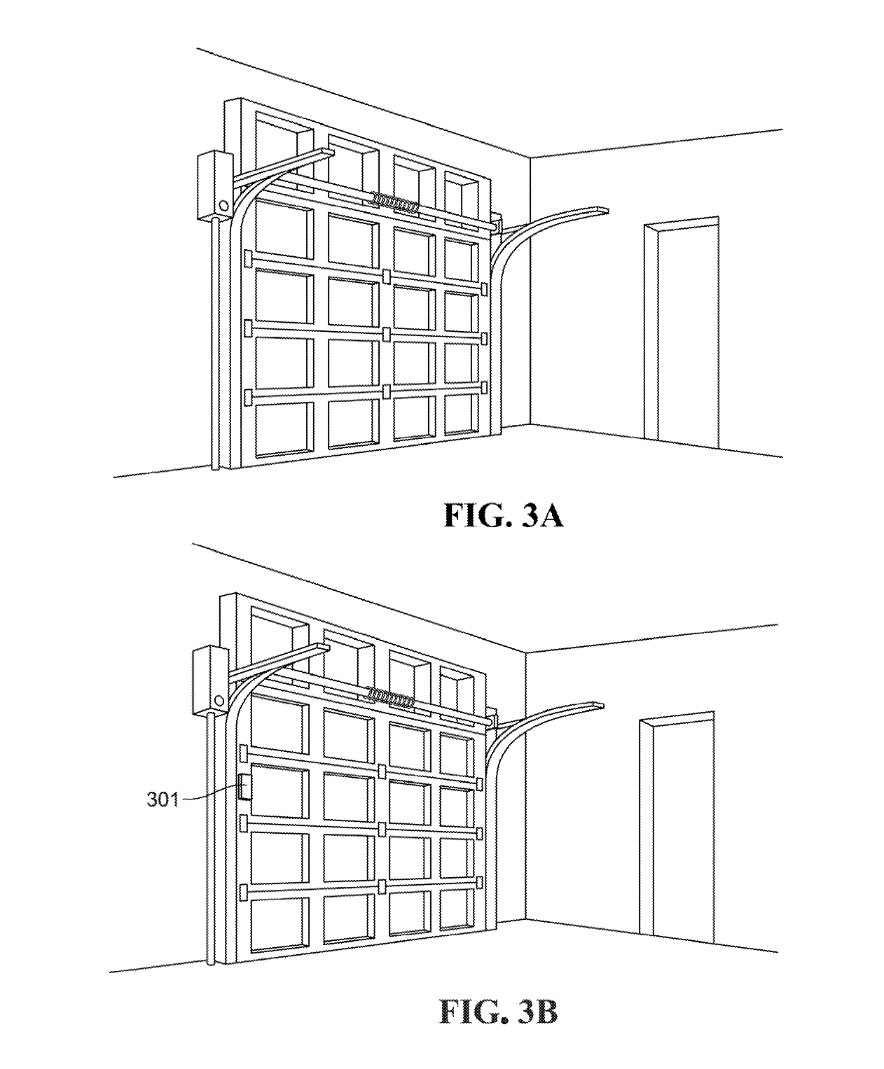

FIG. 3A shows a typical overhead garage door. The illustrated overhead garage door includes several panels hinged together that roll along a system of tracks guided by rollers. The weight of the door may be balanced by either a torsion spring system, or a pair of extension springs. FIG. 3B shows a garage door as illustrated in FIG. 3A, with an attached removable device 301 according to an implementation of the disclosed subject matter. As illustrated and as disclosed elsewhere herein, an implementation of the removable device typically may not replace an existing apparatus (i.e. the motor and receiver) conventionally used to open and close the garage door. Rather, a device as disclosed herein may include a hand-held or similarly-sized device that may be attached to a garage door by an attachment mechanism such as a magnet, a pre-applied adhesive, a drying adhesive, or similar mechanism on the device. Although FIGS. 3A and 3B illustrate an example of a device as disclosed herein attached to a garage door, it will be understood that similar devices may be used with other types of doors, with appropriate sensors as will be readily understood by one of skill in the art.

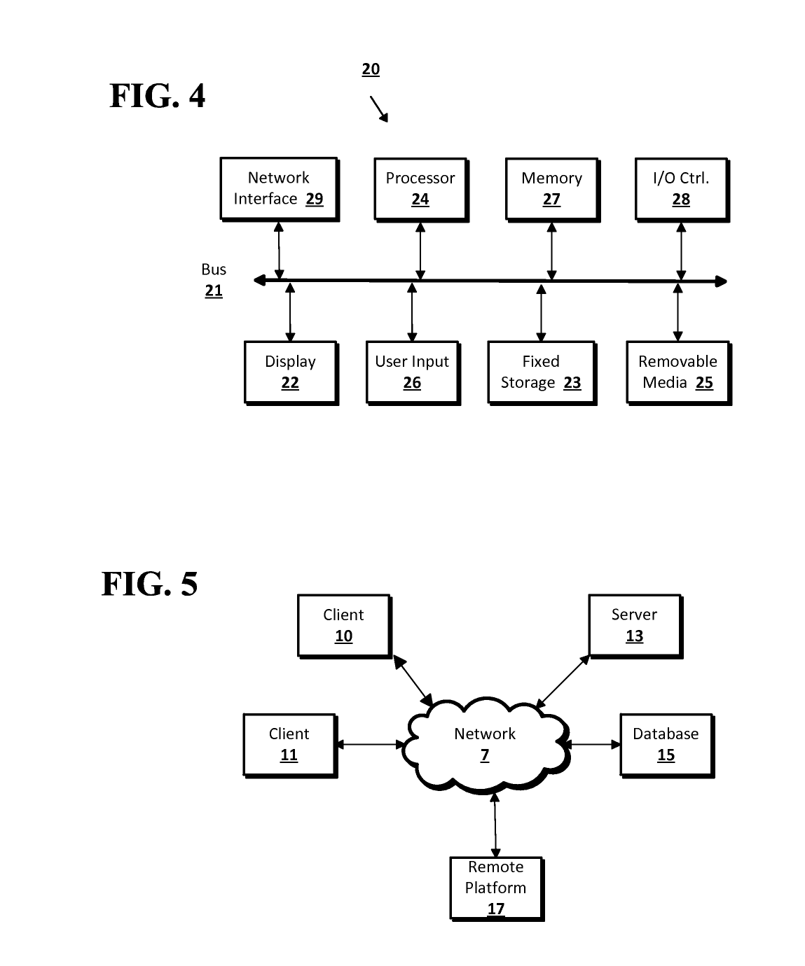

Implementations of the presently disclosed subject matter also may be implemented in and used with a variety of component and network architectures. FIG. 4 is an example computer 20 suitable for implementing embodiments of the presently disclosed subject matter, for example, as part of a home automation system, desktop computer that allows communication with, or control of, a device such as a device 200, or the like. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS), which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an Internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 5.

Many other devices or components (not shown) may be connected in a similar manner (e.g., document scanners, digital cameras and so on). Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, removable media 25, or on a remote storage location.

FIG. 5 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general-purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
receiving a first signal from a first position sensor located within a removable device attached to a door;
determining the state of the door based upon the first signal;
indicating, over a wireless network, the state of the door to a user; and
receiving a command from the user, via the wireless network, to change the state of the door.

2. A method as recited in claim 1, wherein the door is a garage door.

3. A method as recited in claim 1, further comprising receiving a second signal from a second position sensor located within the removable device attached to the door, and determining the state of the door based upon the second signal.

4. A method as recited in claim 1, further comprising sending a signal to the door to change the state of the door.

5. A method as recited in claim 1, wherein the removable device comprises at least one position sensor and a wireless transmitter.

6. A method as recited in claim 1, wherein the removable device comprises an attachment mechanism for attaching to the door.

7. A method as recited in claim 1, wherein the user is a person using a mobile device.

8. A method as recited in claim 1, wherein the user is an automated system.

9. A method as recited in claim 1, wherein the state of the door comprises an indication of whether the door is open, closed, or partially open.

10. A device comprising:
a first position sensor configured to obtain a state of a door;
a processor configured to indicate, over a wireless network, the state of the door to a user;
a first wireless transmitter configured to receive a command from the user to change the state of the door; and
an attachment mechanism for attaching to the door.

11. A device as recited in claim 10, further comprising a second position sensor configured to obtain the state of the door.

12. A device as recited in claim 10, wherein the attachment mechanism is configured to attach the device to a garage door.

13. A device as recited in claim 10, further comprising a second wireless transmitter configured to send a signal to a door opener to change the state of the door.

14. A device as recited in claim 10, wherein the user is a person using a mobile device.

15. A device as recited in claim 10, wherein the user is an automated system.

16. A device as recited in claim 10, wherein the state of the door comprises an indication of whether the door is open, closed, or partially open.

17. A device as recited in claim 10, wherein the device weighs no more than 280 grams.

18. A device as recited in claim 10, wherein the device weighs no more than 140 grams.

19. A device as recited in claim 10, wherein the device comprises at least one dimension which is no more than 60 mm thick.

20. A device as recited in claim 10, wherein the device comprises at least one dimension which is no more than 116 mm in length.
